(19) United States
(12) Patent Application Publication
(10) Pub. No.: US 2015/0112876 A1
(43) Pub. Date: Apr. 23, 2015

(54) METHOD AND SYSTEM FOR PRESENTING WASTE SORTING INFORMATION

(71) Applicants: TOSHIBA TEC KABUSHIKI KAISHA, Tokyo (JP); KABUSHIKI KAISHA TOSHIBA, Tokyo (JP)

(72) Inventor: Susumu HAKAMADA, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/060,977

(22) Filed: Oct. 23, 2013

(51) Int. Cl. G06Q 10/00

(52) U.S. Cl. CPC G06Q 10/30
USPC 705/308

(57) ABSTRACT

According to an embodiment, a method for providing information related to a product comprises receiving an input including information regarding a product purchased by a customer, and detecting a type of the product purchased by the customer. The method further comprises acquiring information related to how to dispose of the product in accordance with the detected type, and outputting the information.

### FIELD

Embodiments described herein relate generally to a method and a system for providing information related to a product, especially information related to how to dispose of the product.

### BACKGROUND

Usually, a store which sells a product is provided with a point of sales (POS) terminal with which a sales clerk can input information about the product when a customer buys the product. In addition, recently, stores provided with a Multifunction Peripheral (MFP) for convenience of a customer who needs a copy service or a facsimile service have increased.

For example, there is a system in which a database of cooking recipes is included in an MFP, and prices of products listed in a specific cooking recipe are discounted when the recipe is printed from the MFP. Such a system is located in a store, and both a POS terminal and the MFP are associated with each other in such a system.

### DESCRIPTION OF THE DRAWINGS

FIG. 1 is a diagram which illustrates an entire configuration of a system according to an embodiment.

FIG. 2 is a flowchart showing operations carried out in a POS terminal of the system according to the embodiment.

FIG. 3 is a flowchart showing operations carried out in an MFP of the system according to the embodiment.

FIG. 4 illustrates an example of a relationship between a type of a product which is stored in a product waste relationship unit included in the system according to the embodiment in FIG. 1 and waste sorting information.

FIG. 5A illustrates an example of a list of purchased products input to the POS terminal of the system according to the embodiment.

FIG. 5B illustrates an example of a sheet on which waste sorting information about the purchased products is printed.

### DETAILED DESCRIPTION

In general, according to an embodiment, a method for providing information related to a product comprises receiving an input including information regarding a product purchased by a customer, and detecting a type of the product purchased by the customer. The method further comprises acquiring information related to how to dispose of the product in accordance with the detected type, and outputting the information.

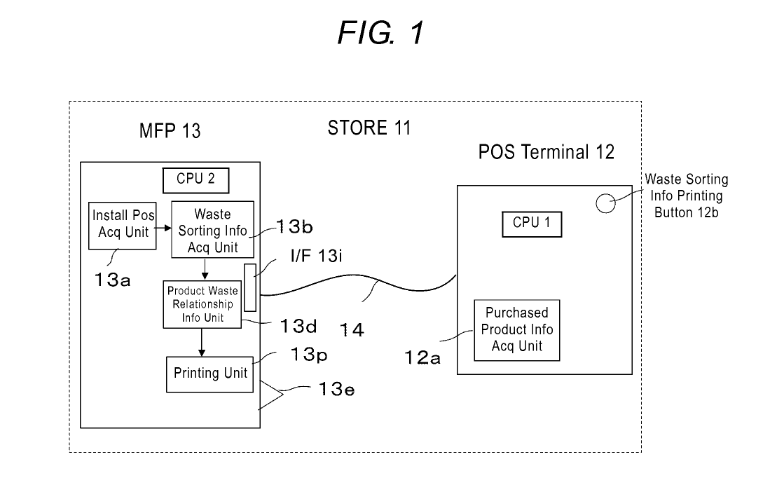

Hereinafter, exemplary embodiments will be described with reference to drawings. A system configuration of the embodiment is illustrated in FIG. 1. A POS terminal 12 as a first terminal, and an MFP 13 as a second terminal are located in a store 11, and these are connected through a cable 14 or wirelessly. In addition, the POS terminal 12 and the MFP 13 are associated with each other, and are located in the same store.

The POS terminal 12 performs an input processing, a calculation, adding up, and the like for products that are purchased by a customer. Accordingly, the POS terminal 12 includes a CPU 1 as a controller, an input unit including keys or the like with which an amount of money can be input, a ROM which stores a program or the like, a RAM which temporarily stores data or the like, a calculation processing unit which performs calculation processing, a display unit which displays a product name and a unit price of a purchased product, an amount of money received from a customer, or the like, a printing unit which prints a receipt, and an interface unit (IF unit) which transmits data to and receives data from the outside. In addition, though it is not shown, when a sales clerk inputs a type of a product, the number of purchased products, a unit price, and a total amount of the products are displayed on a display screen. When multiple products are purchased, a unit price, the number of purchases of each type of product, a total amount of the whole purchased products, and the like are added up and displayed.

When a customer pays in cash for the product, the sales clerk receives money and inputs the amount of money. When there is a remaining amount (change) after subtracting the total amount of purchase from the received money, the sales clerk returns the remaining amount to the customer. The types, the number, the unit price of the purchased products, the received amount of money, and the remaining amount at that time are printed, and are handed to the customer.

The POS terminal 12 further includes a purchased product information acquiring unit 12a, in which information related to a type of a product purchased by a customer is stored, and a waste sorting information printing button 12b, which is to be pressed when waste sorting information is needed.

The purchased product information acquiring unit 12a and the waste sorting information printing button 12b are controlled by the CPU 1. The purchased product information acquiring unit 12a stores product information which is input in the input device. When the waste sorting information printing button 12b is pressed, waste sorting information for a purchased product is printed out from the MFP 13 as described later.

The MFP 13 includes an installation position acquiring unit 13a which detects a location at which the device is located, for example, using a Global Positioning System (GPS), a waste sorting information acquiring unit 13b which acquires sorting information related to how to dispose of the purchased product as a waste in a region in which the installation location is included, a product waste relationship information unit 13d which stores a relationship between a product and a category of the product as a waste, an interface unit 13i through which information can be input from the outside, a printing unit 13p which prints the waste sorting information, and a central processing unit (CPU 2) which controls each of the above-described units. The printing unit 13p may be used for other purposes such as copying of a document or printing of information received by a fax machine and may carry out a color printing.

The CPU 2 causes the installation position acquiring unit 13a to detect a location of the store 11 in which the MFP 13 is provided. Further, the CPU 2 causes the waste sorting information acquiring unit 13b to acquire information related to waste sorting in a region in which the location acquired by the installation position acquiring unit 13a is included. If local municipalities notify each company or family of the information through a network, the information can be received and acquired by the MFP 13 through the network. If the waste sorting information is distributed offline, the information is manually input to the waste sorting information acquiring unit 13b.

The information about the product purchased by a customer, which is acquired by the purchased product information acquiring unit 12a of the POS terminal 12, is received in the MFP 13 through the cable 14, and is input to the product waste relationship unit 13d. The product information received by the MFP 13 is information which can identify the product such as a name, a type of the product, or the like, in detail.

On the other hand, the waste sorting information acquired by the waste sorting information acquiring unit 13b is mainly a day of a week or a date in a month on which a type of a waste is collected. For example, if the waste is resource recyclable plastic, the days of collecting recyclable materials may be every Wednesday in the region. If the waste is burnable, a day of collecting burnable waste may be every Tuesday or Saturday. If the waste is a landfill waste, a day of collecting landfill waste may be on the 15^{th} of every month, or the like.

A waste collecting day corresponding to such categories may be considerably different depending on a region. Waste may be collected on the same day depending on types of the waste. Also, types of waste which can be collectively collected are also considerably different depending on a region. When moving to a new region due to relocating or the like, a detailed manual related to waste collecting in the region may be distributed. The CPU 2 supplies the waste sorting information in the region acquired by the waste sorting information acquiring unit 13b to the product waste relationship unit 13d.

The waste collecting day according to a type of the waste is correlated with the product. Other pieces of information related to waste sorting may also be correlated with the product as notes. The correlation information is stored in the product waste relationship unit 13d.

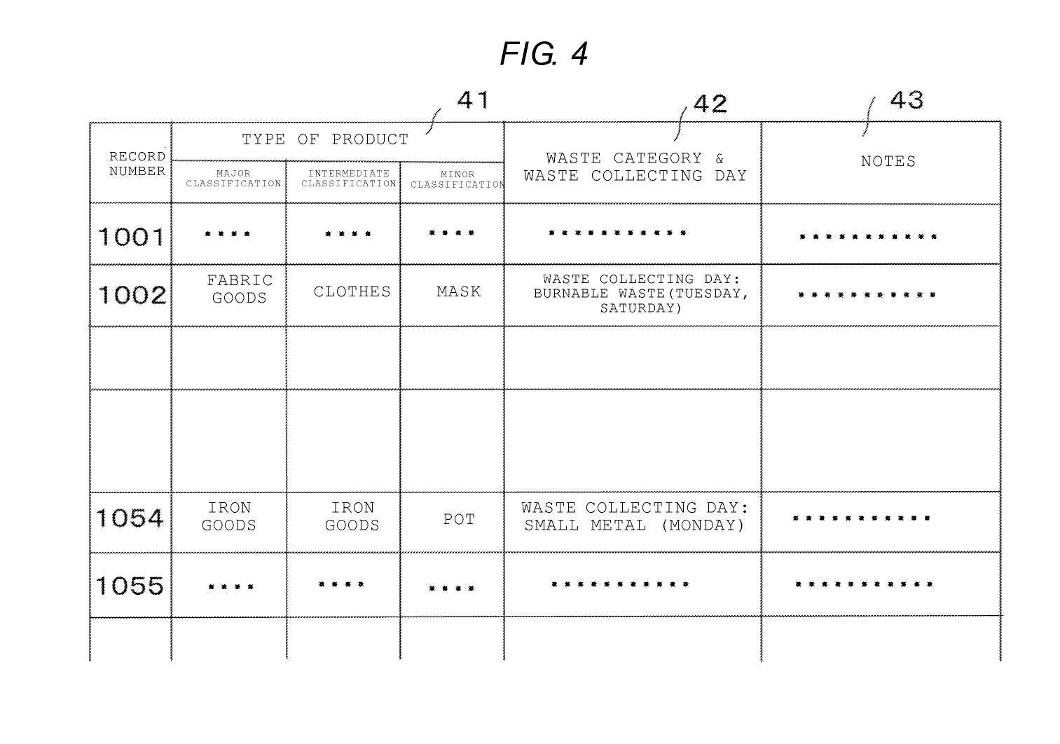

An example of the correlation information stored in the product waste relationship unit 13d is illustrated in FIG. 4. With respect to each record number, a type of product is stored in a column 41, a waste collecting day is stored in the rightward column 42 thereof, and notes related to waste sorting and collecting of the product are stored in a column 43.

The type of the product is classified into a major classification, an intermediate classification, and a minor classification. For example, an item of record number 1002 is categorized as fabric goods, clothes, a mask, with respect to each of the classifications, and an item of record number 1054 is categorized as metal goods, iron goods, pots, respectively. It is preferable that the minor classification is described minutely, and in detail as much as possible.

The waste collecting day and the notes not only correspond to the minor classification of the type of the product, but also correspond to the intermediate classification. Further, the waste collecting day and the notes may correspond to another intermediate classification and another minor classification in another major classification. In such a case, the same waste collecting day and the notes are stored in two places or more. For example, in a region where aluminum cans and plastic are collected on a same day, the same contents are stored in the columns of the waste collecting day and notes with respect to both aluminum cans and plastics.

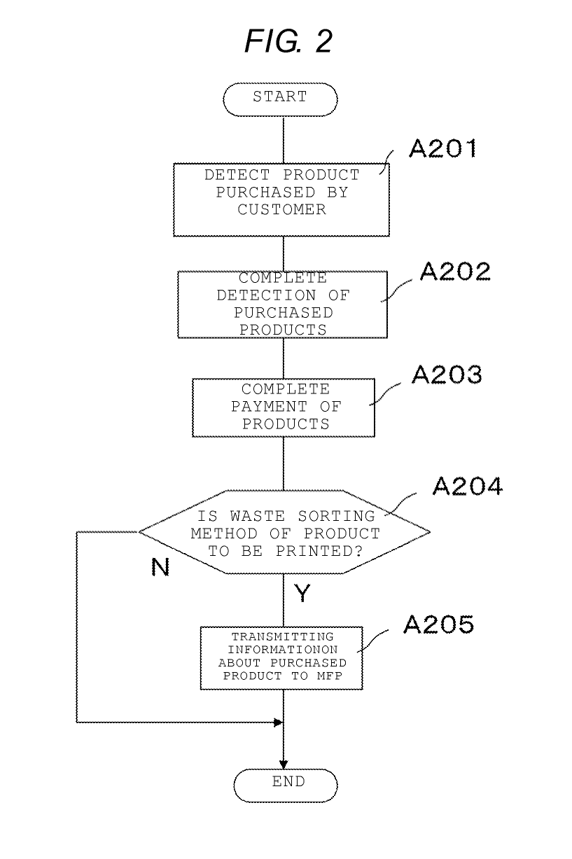

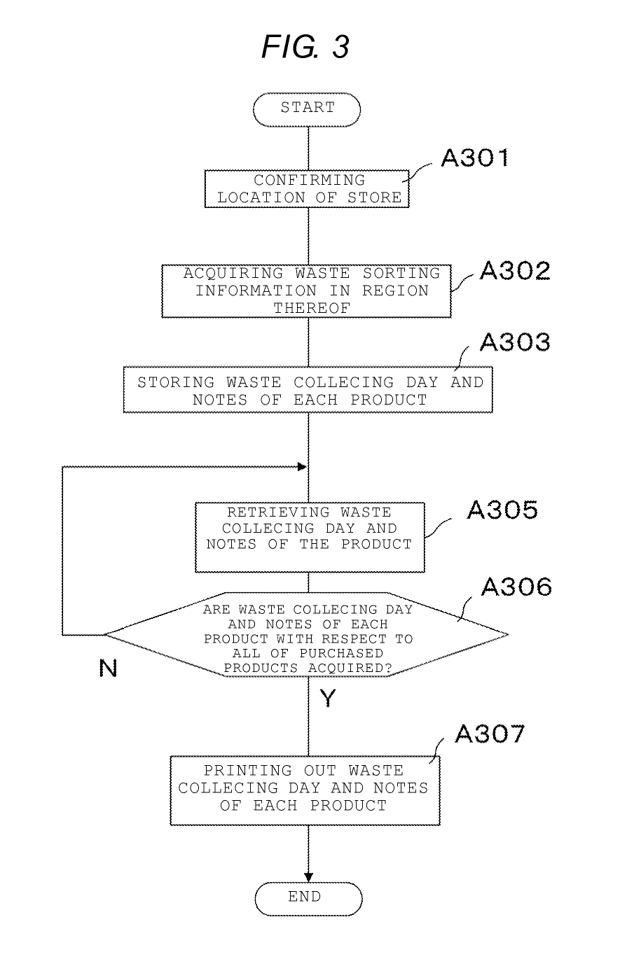

Next, operations carried out in the system according to the embodiment will be described based on flowcharts of FIGS. 2 and 3. FIG. 2 is a flowchart which illustrates an operation carried out in the POS terminal 12 in the store 11. FIG. 3 is a flowchart which illustrates an operation carried out in the MFP 13.

Usually, when a customer carries a product which is purchased at a store to a cash register by putting the product in a basket, a sales clerk, that is, an operator of the POS terminal 12, inputs a price of each product to the POS terminal 12 and causes the terminal to calculate a total amount. The sales clerk receives bills and coins from the customer, inputs the received amount to the POS terminal 12, subtracts the total amount of the purchased products from the received money. If there is a remaining amount, the amount is paid to the customer. The type of products, the unit price of each product, the total amount of each product, the money received from the customer, the change, and the like are recorded in the POS terminal, or an external server (not shown) which is connected thereto.

Accordingly, as a matter of course, the POS terminal 12 acquires information about a type of the product and a name of a product which are purchased by a customer, and stores the information in the purchased product information acquiring unit 12a.

In A201 in FIG. 2, the CPU 1 detects inputs of information about each product purchased by a customer, and in A202, the CPU 1 performs an input processing in response to a total key, which denotes that all of inputs of information about the purchased products are completed, being pressed. That is, the CPU 1 inputs decision information-indicating that a customer makes a decision to purchase a product-to a storage unit (not shown). This input processing is performed as a part of a product purchase procedure in the POS terminal 12. In A203, the CPU 1 calculates the total amount of the purchased products.

In A204, the CPU 1 determines whether or not printing of a waste sorting method of the product is necessary. The determination of whether or not to print the waste sorting method is determined based on whether or not the waste sorting information printing button 12b is pressed.

If the waste sorting information printing button 12b is pressed in A204 (Y in A204), the CPU 1 causes the product name, a category thereof, or the like to be temporarily stored in the purchased product information acquiring unit 12a. Thereafter, in A205, in the CPU 1, the information about the purchased product which is stored in the purchased product information acquiring unit 12a is transmitted to the MFP 13 in the store 11. The transmission of the purchased product information may be performed in a wired manner or wirelessly.

In addition, if the waste sorting information printing button 12b is not pressed, that is, if the waste sorting information about the purchased product is not to be printed (N in A204), the CPU 1 ends the product purchase procedure without printing the waste sorting information.

If the waste sorting information about the purchased product is to be printed, the MFP 13 prints the waste sorting method through a procedure illustrated in FIG. 3.

The flowchart in FIG. 3 starts due to reception of the purchased product information transmitted from the purchased product information acquiring unit 12a of the POS terminal 12. The received purchased product information is stored in the product waste relationship unit 13d.

In A301, the CPU 2 causes the installation position acquiring unit 13a to acquire a location of the store 11 in which the MFP 13 is provided. In A302, the CPU 2 causes the waste sorting information acquiring unit 13b to acquire the waste sorting information. The waste sorting information typically includes a waste collecting day, and any notes related to the waste collecting.

The CPU 2 causes the waste collecting day of each product and the notes to be transmitted to the product waste relationship unit 13d from the waste sorting information acquiring unit 13b. In A303, the CPU 2 causes the pieces of waste sorting information transmitted to the product waste relationship unit 13d to be stored in the product waste relationship unit 13d in accordance with types of products.

In A305, the CPU 2 retrieves waste sorting information (waste collecting day and notes) corresponding to each of the purchased products from the product waste relationship unit 13d. In A306, the CPU 2 detects whether or not the waste collecting day, and the notes are acquired with respect to all of the products purchased by the customer. If there is a purchased product for which information has not been retrieved yet, the process returns to A305, and the waste collecting day and the notes of the product are retrieved.

If retrieving of all of the purchased products is ended, the CPU 2 instructs the printing unit 13p to print the waste collecting day and the notes with respect to each purchased product in A307.

As a result, for example, an A4 sheet on which the waste collecting day and the notes with respect to all of the purchased products are printed is discharged from a sheet outlet 13e.

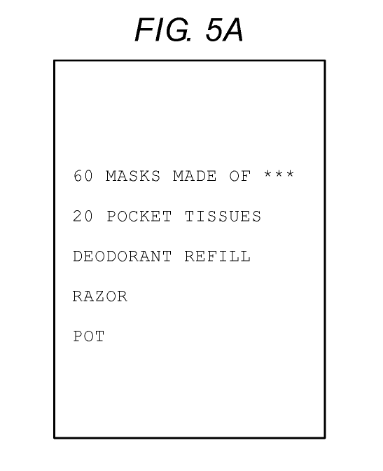

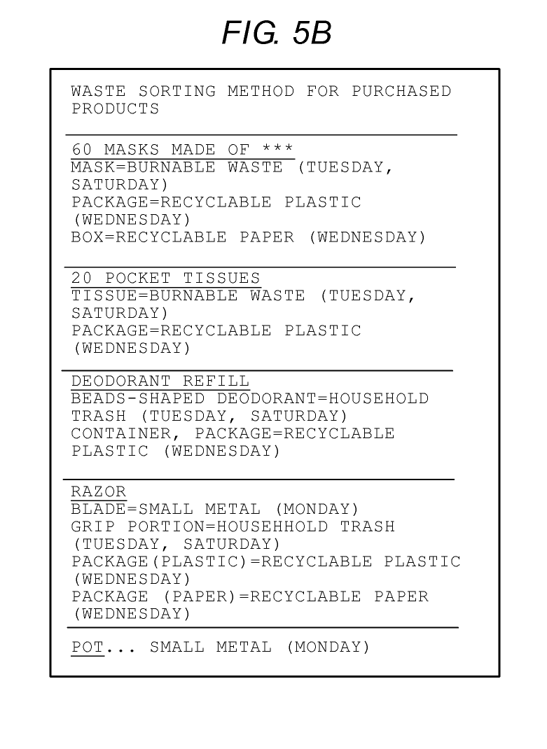

FIG. 5A illustrates an example of a list of the purchased products which are input in the POS terminal 12. This case is an example in which 60 masks, 20 pocket tissues, a deodorant refill, a razor, and a pot are purchased. A product without a number denotes that the number is one.

FIG. 5B is an example of a sheet on which a waste sorting method of the purchased products is printed in case that the products shown in the list of FIG. 5A are purchased. In the example, as waste sorting information, only collecting days are printed without the notes for the waste sorting.

Regarding the “60 masks”, the product is classified into “mask”, “package”, and “box” by the store based on the waste sorting information acquired from a local municipality and product information acquired from a producer. The classes of the product and collecting days of each class are shown. According to the waste sorting information acquired from a local municipality, a “mask” is, in the local region, categorized as a burnable waste, of which collecting days are Tuesday and Saturday. “package” is, in the region, categorized as recyclable plastic, of which collecting day is Wednesday. In addition, “box” is, in the region, categorized as recyclable paper, of which collecting day is Wednesday.

Similarly, the “20 pocket tissues” are classified into a “tissue” and a “package.” “tissue” is categorized as burnable waste and collected on Tuesday and Saturday, and “package” is categorized as recyclable plastic and collected on Wednesday.

Similarly, “deodorant refill” is separately considered as “beads-shaped deodorant” and “container, package”, and these are collected on each predetermined day as household trash, and recyclable plastic, respectively. In addition, “razor” is classified into “blade”, “grip”, “package (plastic)”, and “package (paper)”, each of which is categorized into small metal, household trash, recyclable plastic, and recyclable paper, respectively, and these are collected on predetermined days. In addition, “pot” is collected on Monday as small metal.

According to the embodiment, a store provided with the POS terminal and the MFP is described. However, the MFP is not essential, and at least a device with a printing function such as a printer which is connected to the POS terminal in a wired manner or wirelessly, and can print the waste sorting method may be used. In addition, a sheet printed by the device with the printing function is not limited to an A4 sheet, may be a B5 sheet or a sheet of a size other than a receipt size, and may be, in a word, a regular sheet.

According to the embodiment, the installation position acquiring unit 13a and the waste sorting information acquiring unit 13b are provided in the MFP. However, the units may be provided in the POS. In addition, though the installation position acquiring unit 13a, the waste sorting information acquiring unit 13b, and the like are included in the MFP, these units may be included in a server which is different from the MFP and the POS terminal. In this case, the server may not be located in the store in which the POS terminal and the MFP are placed, and may be collectively managed in a separate viewpoint from an administrative division. In this case, a device including the installation position acquiring unit 13a and the waste sorting information acquiring unit 13b becomes a device which provides the waste sorting information.

A case in which products are purchased is described in the embodiment. However, the embodiment may be applied to products which are obtained at a cost, or free of cost by a customer.

According to the embodiment, information about all of the purchased products is input to the POS terminal, and a brief description of each purchased product is output in response to the total key being pressed. However, it is not limited to this, and the decision to transact products may be performed based on each input of information about an individual product, and the information may be sequentially transmitted to the MFP.

According to the embodiment, a case is described in which a program for executing the exemplary embodiment is stored in advance in the device. However, it is not limited to this, and the same program may be downloaded to the device from a network. As a storage medium, a medium in any form may be used as long as the medium is a storage medium such as a CD-ROM which can store a program and is readable by the device.

In addition, such a program which can be installed or downloaded in advance may be a program which can be achieved by cooperating with an operating system (OS) in the device.

According to the embodiment, it is possible to provide a waste sorting information presenting method in which waste sorting information of a product can be easily printed, and provided to a customer, when the product is purchased in a store or the like, which is provided with the POS terminal and a printer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A method for providing information related to a product comprising:
receiving an input including information regarding a product purchased by a customer;
detecting a type of the product purchased by the customer;
acquiring information related to how to dispose of the product in accordance with the detected type; and
outputting the information.

2. The method according to claim 1, wherein the information is output in response to detection of an input instructing the printing of the information.

3. The method according to claim 2, wherein the information is output by printing the information on a sheet.

4. The method according to claim 3, further comprising:
acquiring information related to a location where the product is purchased by the customer,
wherein the acquired information related to how to dispose of the product is unique to the location.

5. The method according to claim 1, wherein the receiving of the input is carried out in a first device, and the printing of the information is carried out in a second device that is different from the first device.

6. The method according to claim 5, wherein the first device is a POS terminal, and the second device is a printing device.

7. The method according to claim 5, wherein the information related to the type of the product is transmitted from the first device to the second device in response to the detection of the input, and the information related to how to dispose of the product is output in response to the second device receiving the information related to the type of the product.

8. The method according to claim 1, wherein the information related to how to dispose of the product includes information about which category of waste the product is categorized in.

9. The method according to claim 1, further comprising:
storing the acquired information related to how to dispose of the product.

10. A system for providing information related to a product comprising:
an input unit configured to receive an input including information regarding a product purchased by a customer;
a detecting unit configured to detect a type of the product purchased by the customer;
an acquiring unit configured to acquire information related to how to dispose of the product in accordance with the type detected by the detecting unit; and
an outputting unit configured to output the information.

11. The system according to claim 10, wherein the information is output in response to detection of an input instructing the printing of the information.

12. The system according to claim 11, wherein the information is output by printing the information on a sheet.

13. The system according to claim 12, further comprising:
a location acquiring unit configured to acquire information related to a location where the product is purchased by the customer,
wherein the information acquired by the acquiring unit is unique to the location.

14. The system according to claim 12, wherein the input unit and the detecting unit are included in a first device, and the outputting unit is included in a second device that is different from the first device.

15. The system according to claim 14, wherein the first device is a POS terminal, and the second device is a printing device.

16. The system according to claim 14, wherein the information related to the type of the product is transmitted from the first device to the second device in response to the input, and the information related to how to dispose of the product is output based on the information related to the type of the product.

17. The system according to claim 14, wherein the information related to how to dispose of the product is information about which category of waste the product is categorized in.

18. The system according to claim 10, further comprising:
a storing unit configured to store the information acquired by the acquiring unit.

19. A device comprising:
an input unit configured to receive an input including information regarding a product purchased by a customer;
a detecting unit configured to detect a type of the product purchased by the customer;
an acquiring unit configured to acquire information related to how to dispose of a product that is purchased by a customer in accordance with a type of the product; and
an interface unit configured to output the information related to how to dispose of the product to an output device.

20. The device according to claim 19, further comprising:
a location acquiring unit configured to acquire information related to a location where the product is purchased by the customer,
wherein the information acquired by the acquiring unit is unique to the location.
